(19) United States
(12) Patent Application Publication
(10) Pub. No.: US 2023/0087699 A1
(43) Pub. Date: Mar. 23, 2023

(54) COMMUNICATION DEVICE, TERMINAL DEVICE, AND DATA STRUCTURE OF WIRELESS SIGNAL

(71) Applicant: KABUSHIKI KAISHA TOKAI RIKA DENKI SEISAKUSHO, Aichi (JP)

(72) Inventors: Masateru FURUTA, Aichi (JP); Shigenori NITTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/794,493

(22) PCT Filed: Dec. 2, 2020
(86) PCT No.: PCT/JP2020/044786

§ 371 Date: Jul. 21, 2022

(30) Foreign Application Priority Data
Mar. 5, 2020 (JP) 2020-037392

(51) Int. Cl. H04W 64/00

(52) U.S. Cl. CPC H04W 64/00

(57) ABSTRACT

A communication device that is included in a plurality of communication devices performing wireless communication with a terminal device, the communication device including: a wireless communication part that receives a wireless signal containing a plurality of pieces of result information including first result information obtained by wireless communication between the terminal device and the communication device and second result information obtained by wireless communication between the terminal device and another communication device of the plurality of communication devices; and a control part that outputs the plurality of pieces of result information contained in the wireless signal to a control device that performs communication with each of the communication devices.

### TECHNICAL FIELD

The present invention relates to a communication device, a terminal device, and a data structure of a wireless signal.

### BACKGROUND ART

Recently, there have been developed various technologies for measuring a distance between devices (hereinafter, also referred to as distance measurement). For example, the following Patent Literature 1 discloses the technology of measuring a distance between devices on the basis of a period of time from the transmission of a wireless signal for distance measurement to the reception of a wireless signal as a response thereto.

### CITATION LIST

### Patent Literature

Patent Literature 1: JP H11-208419A

### SUMMARY OF INVENTION

### Technical Problem

However, in the technology disclosed in the above-described Patent Literature 1, the measurement of a distance between devices of one-to-one relation is premised. Therefore, in the processing of specifying a distance between devices of one-to-many relation, there has been a room for improvement.

In view of the above-described problem, the present invention aims at providing a mechanism capable of more appropriately performing processing based on one-to-many wireless communication.

### Solution to Problem

To solve the above described problem, according to an aspect of the present invention, there is provided a communication device that is included in a plurality of communication devices performing wireless communication with a terminal device, the communication device comprising: a wireless communication part that receives a wireless signal containing a plurality of pieces of result information including first result information obtained by wireless communication between the terminal device and the communication device and second result information obtained by wireless communication between the terminal device and another communication device of the plurality of communication devices; and a control part that outputs the plurality of pieces of result information contained in the wireless signal to a control device that performs communication with each of the communication devices.

To solve the above described problem, according to another aspect of the present invention, there is provided a terminal device performing wireless communication with each of a plurality of communication devices, the terminal device comprising: a wireless communication part that transmits a wireless signal containing a plurality of pieces of result information obtained by wireless communication performed between the terminal device and each of the communication devices.

To solve the above described problem, according to another aspect of the present invention, there is provided a data structure of a wireless signal used in a communication system including a terminal device and a plurality of communication devices, the data structure comprising: a plurality of pieces of result information obtained by wireless communication performed between the terminal device and each of the communication devices, at a position defined for each of the communication devices.

### Advantageous Effects of Invention

As described above, the present invention provides a mechanism capable of more appropriately performing processing based on one-to-many wireless communication.

### BRIEF DESCRIPTION OF DRAWINGS

FIG. 1 is a diagram illustrating an example of a configuration of a system according to an embodiment of the present invention.

FIG. 2 is a sequence diagram illustrating an example of a basic flow of distance measurement processing performed in the system according to the embodiment.

FIG. 3 is a diagram for explaining an example of a data structure of a wireless signal received by a communication device according to the embodiment.

FIG. 4 is a sequence diagram illustrating an example of a flow of distance measurement processing performed in the system according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

Moreover, in this specification and drawings, elements that have substantially the same function and structure may be distinguished by adding different alphabets after the same reference sign. For example, a plurality of elements that have substantially the same function and structure are distinguished as communication devices 210A and 210B, if necessary. However, if it is not necessary to particularly distinguish each of the elements that have substantially the same function and structure, only the same reference sign is given. For example, if it is not necessary to particularly distinguish the communication device 210A from the communication device 210B, they are referred to simply as the communication device 210.

### 1. Configuration Example

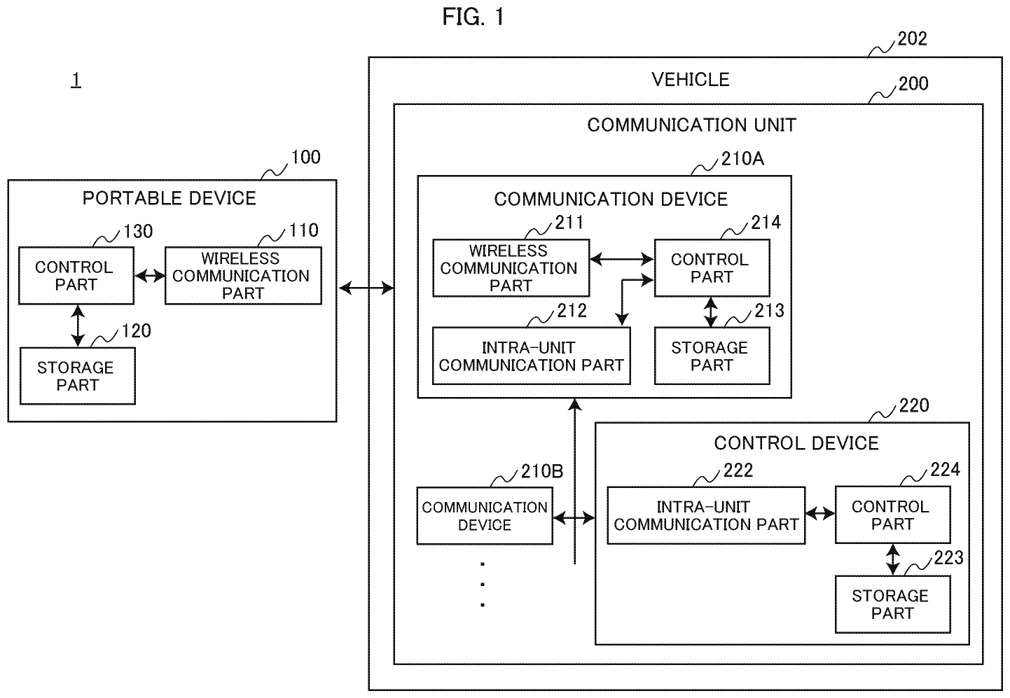

FIG. 1 is a diagram illustrating an example of a configuration of a system 1 according to an embodiment of the present invention. As illustrated in FIG. 1, the system 1 of the embodiment includes a portable device 100 and a communication unit 200. The communication unit 200 of the embodiment is provided in a vehicle 202. The vehicle 202 is an example of the target to be used by a user. The system 1 is an example of the communication system.

The present invention involves a device as an authenticated party and a device as an authenticating party. The portable device 100 is an example of the device as an authenticated party. The communication unit 200 is an example of the device as an authenticating party.

When a user (a driver of the vehicle 202, for example) approaches the vehicle 202 with the portable device 100, wireless communication for authentication is performed between the portable device 100 and the communication unit 200. Then, if the authentication has succeeded, the door lock of the vehicle 202 is unlocked or the engine is started, so that the vehicle 202 becomes available for the user. The system 1 is also referred to as a smart entry system. The following will sequentially describe each structural element.

(1) Portable Device 100

The portable device 100 is an example of the terminal device. The portable device 100 is formed as an arbitrary device carried by a user. Examples of the arbitrary device include an electronic key, a smartphone, a wearable terminal, and the like.

As illustrated in FIG. 1, the portable device 100 includes a wireless communication part 110, a storage part 120, and a control part 130.

The wireless communication part 110 has a function of performing communication conforming to a given wireless communication standard, with the communication unit 200. The wireless communication part 110 performs wireless communication with each of a plurality of communication devices 210 included in the communication unit 200. The wireless communication part 110 is formed as a communication interface allowing communication conforming to a given wireless communication standard, for example.

For example, in a given wireless communication standard, a signal using an ultra-wide band (UWB) may be used. The signal of an impulse system in the UWB is characterized in being capable of performing distance measurement with high accuracy. That is, the signal of an impulse system in the UWB uses radio waves with a considerably short pulse width of a nanosecond or shorter, whereby it is possible to measure air propagation time of radio waves with high accuracy and thus perform distance measurement based on propagation time with high accuracy. Here, the distance measurement indicates the measurement of a distance between devices transmitting and receiving signals.

In the following, it is supposed that the wireless communication part 110 transmits and receives signals using the UWB.

The storage part 120 has a function of storing various kinds of information for the operation of the portable device 100. For example, the storage part 120 stores a program for the operation of the portable device 100, and an identifier (ID), a password, an authentication algorithm, and the like, for authentication. The storage part 120 is formed by, for example, a storage medium such as a flash memory and a processing device that performs recording onto a storage medium and reproduction.

The control part 130 has a function of controlling the entire operation of the portable device 100. As an example, the control part 130 controls the wireless communication part 110 to perform communication with the communication unit 200. Moreover, the control part 130 reads out information from the storage part 120, and writes information into the storage part 120. The control part 130 is formed by an electronic circuit such as a central processing unit (CPU) and a microprocessor, for example.

(2) Communication Unit 200

The communication unit 200 is provided corresponding to the vehicle 202. Here, it is supposed that the communication unit 200 is provided in the vehicle 202. As an example of the mounting position, the communication unit 200 is provided in the vehicle interior of the vehicle 202, or the communication unit 200 is embedded as a communication module in the vehicle 202. As illustrated in FIG. 1, the communication unit 200 includes a plurality of communication devices 210 (210A, 210B, and the like) and the control device 220. Note that the communication unit 200 may include three or more communication devices 210.

Communication Device 210

The communication device 210 is a device that performs wireless communication with the portable device 100.

As illustrated in FIG. 1, the communication device 210A includes a wireless communication part 211, an intra-unit communication part 212, a storage part 213, and a control part 214. Note that the other communication devices 210 such as the communication device 210B also include the same structural elements as the communication device 210A.

The wireless communication part 211 has a function of performing communication conforming to a given wireless communication standard, with the portable device 100. The wireless communication part 211 is formed as a communication interface allowing communication conforming to a given wireless communication standard, for example. In the following, it is supposed that the wireless communication part 211 transmits and receive signals using the UWB.

The intra-unit communication part 212 has a function of performing communication with other devices included in the communication unit 200. As an example, the intra-unit communication part 212 performs communication with the control device 220. As another example, the intra-unit communication part 212 performs communication with the other communication devices 210. The intra-unit communication part 212 is formed as a communication interface allowing communication conforming to an arbitrary in-vehicle network standard such as a local interconnect network (LIN) or a controller area network (CAN), for example.

The storage part 213 has a function of storing various kinds of information for the operation of the communication device 210. For example, the storage part 213 stores a program for the operation of the communication device 210, and an identifier (ID), a password, an authentication algorithm, and the like, for authentication. The storage part 213 is formed by, for example, a storage medium such as a flash memory and a processing device that performs recording onto a storage medium and reproduction.

The control part 214 has a function of controlling the operation of the communication device 210. As an example, the control part 214 controls the wireless communication part 211 to perform communication with the portable device 100. As another example, the control part 214 controls the intra-unit communication part 212 to perform communication with other devices included in the communication unit 200. As another example, the control part 214 reads out information from the storage part 213, and writes information into the storage part 213. The control part 214 is formed as an electronic control unit (ECU), for example.

Control Device 220

The control device 220 is a device that performs communication with a plurality of communication devices 210.

As illustrated in FIG. 1, the control device 220 includes an intra-unit communication part 222, a storage part 223, and a control part 224.

The intra-unit communication part 222 has a function of performing communication with other devices included in the communication unit 200. As an example, the intra-unit communication part 222 performs communication with the communication device 210. The intra-unit communication part 222 is formed as a communication interface allowing communication conforming to an arbitrary in-vehicle network standard such as a local interconnect network (LIN) or a controller area network (CAN), for example.

The storage part 223 has a function of storing various kinds of information for the operation of the control device 220. For example, the storage part 223 stores a program for the operation of the control device 220, and an identifier (ID), a password, an authentication algorithm, and the like, for authentication. The storage part 223 is formed by, for example, a storage medium such as a flash memory and a processing device that performs recording onto a storage medium and reproduction.

The control part 224 has a function of controlling the operation of the control device 220. As an example, the control part 224 controls the intra-unit communication part 222 to perform communication with other devices included in the communication unit 200. As another example, the control part 224 reads out information from the storage part 223, and writes information into the storage part 223. The control part 224 is formed as an electronic control unit (ECU), for example.

Particularly, the control part 224 performs processing based on the information obtained by wireless communication between each of the communication devices 210 and the portable device 100.

An example of the processing is authentication processing for authenticating the portable device 100. Another example of the processing is processing of controlling the door lock of the vehicle 202, such as locking and unlocking of the door lock. Another example of the processing is processing of controlling a power source, such as start/stop of the engine of the vehicle 202. Note that the power source provided in the vehicle 202 may be a motor or the like, as well as an engine.

### 2. Technical Features

### (1) Distance Measurement Processing

The portable device 100 and the communication unit 200 perform distance measurement processing. The distance measurement processing is processing of measuring a distance between the portable device 100 and the communication unit 200. To be more specific, the distance measurement processing is processing of measuring a distance between the portable device 100 and each of the communication devices 210. In the following, a distance measured by distance measurement processing is also referred to as a distance measurement value.

The distance measurement processing includes transmission and reception of signals for distance measurement processing, and calculation of a distance measurement value based on the information obtained by transmission and reception of signals for distance measurement processing.

An example of the signal for distance measurement processing is a distance measurement signal. The distance measurement signal is a signal that is transmitted and received to measure a distance between devices. The distance measurement signal is also a signal to be measured. For example, time required for transmission and reception of distance measurement signals is measured. The distance measurement signal is typically formed in a frame format not including a payload part where data is stored.

In the distance measurement processing, a plurality of distance measurement signals can be transmitted and received between devices. Among a plurality of distance measurement signals, a distance measurement signal transmitted from one device to another device is also referred to as a first distance measurement signal. Then, a distance measurement signal transmitted from a device having received the first distance measurement signal to a device having transmitted the first distance measurement signal is also referred to as a second distance measurement signal.

Another example of the signal for distance measurement processing is a data signal. The data signal is a signal that stores and transmits data. The data signal is formed in a frame format including a payload part where data is stored.

In the following, the transmission and reception of distance measurement signals in distance measurement processing is also referred to as distance measurement communication. Meanwhile, in the following, the transmission and reception of data signals in distance measurement processing is also referred to as data communication.

In the distance measurement processing, a distance between the portable device 100 and the communication device 210 that have transmitted and received distance measurement signals is measured.

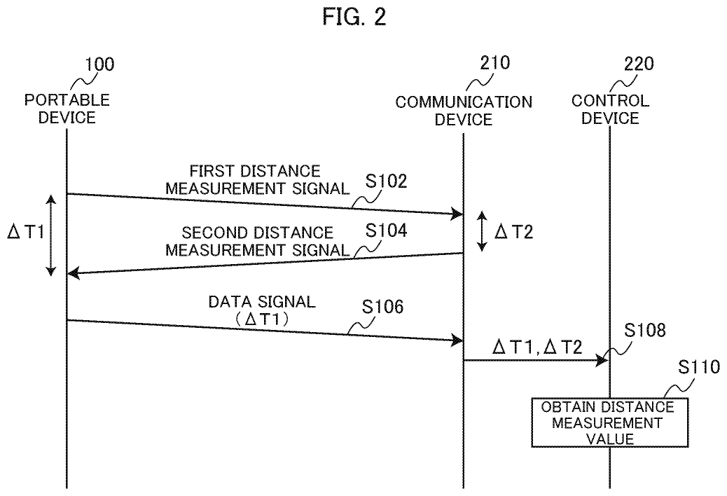

The following will describe an example of a flow of distance measurement processing with reference to FIG. 2.

FIG. 2 is a sequence diagram illustrating an example of a basic flow of distance measurement processing performed in the system 1 according to the embodiment. As illustrated in FIG. 2, this sequence involves the portable device 100, the communication device 210, and the control device 220. That is, this sequence exemplifies a flow of distance measurement processing for measuring a distance between the portable device 100 and one communication device 210.

As illustrated in FIG. 2, the wireless communication part 110 of the portable device 100 first transmits the first distance measurement signal (Step S102). The first distance measurement signal is transmitted as a signal using the UWB.

Having received the first distance measurement signal from the portable device 100, the wireless communication part 211 of the communication device 210 transmits the second distance measurement signal in response to the first distance measurement signal (Step S104). The second distance measurement signal is transmitted as a signal using the UWB.

When the wireless communication part 110 has received the second distance measurement signal, the control part 130 of the portable device 100 measures time ΔT1 from the time of transmission of the first distance measurement signal to the time of reception of the second distance measurement signal. Next, the wireless communication part 110 of the portable device 100 transmits a data signal containing the information indicating the measured ΔT1 (Step S106). The data signal is transmitted as a signal using the UWB.

Meanwhile, the control part 214 of the communication device 210 measures time ΔT2 from the time of reception of the first distance measurement signal to the time of transmission of the second distance measurement signal. Thereafter, when the wireless communication part 211 has received the data signal from the portable device 100, the control part 214 of the communication device 210 outputs ΔT1 contained in the received data signal and the measured ΔT2 to the control device 220 (Step S108).

Then, the control device 220 obtains a distance measurement value indicating a distance between the portable device 100 and the communication device 210 on the basis of ΔT1 and ΔT2 obtained from the communication device 210 (Step S110). For example, the control device 220 first calculates propagation time by dividing ΔT1-ΔT2 by 2. The propagation time here indicates time required for one-way transmission/reception of a signal between the portable device 100 and the communication device 210. Then, the control device 220 calculates a distance measurement value indicating a distance between the portable device 100 and the communication device 210 by multiplying the propagation time by a signal speed.

The above has described an example of a flow of distance measurement processing.

The distance measurement value obtained by distance measurement processing is used for authentication between the portable device 100 and the communication unit 200. For example, when the distance measurement value is equal to or smaller than a given value, the control device 220 determines that the authentication has succeeded. Meanwhile, when the distance measurement value is not equal to or smaller than a given value, the control device 220 determines that the authentication has failed. In the case of measuring a distance on the basis of propagation time, the relay of a distance measurement signal extends propagation time, which prevents a so-called relay attack.

### (2) Technical Problems

The data signal has a lower gain than the distance measurement signal. This is because the data signal is formed in a frame format including a payload part, which is not included in the distance measurement signal. That is, the reception side may fail in receiving a data signal.

If the reception side fails in receiving a data signal, it is difficult to calculate an accurate distance measurement value even when the transmission/reception of a distance measurement signal has succeeded. Therefore, the embodiment provides a mechanism capable of calculating an accurate distance measurement value even if the reception of a data signal has failed.

### (3) Transmission and Reception of a Wireless Signal Including a Plurality of Pieces of Result Information

The communication device 210 receives a wireless signal containing a plurality of pieces of result information obtained by wireless communication performed between the portable device 100 and each of the communication devices 210. Then, the communication device 210 outputs the plurality of pieces of result information contained in the wireless signal to the control device 220. For example, the communication device 210A receives a wireless signal containing a plurality of pieces of result information including the first result information obtained by wireless communication performed between the portable device 100 and the communication device 210A and the second result information obtained by wireless communication performed between the portable device 100 and the communication device 210B. Then, the communication device 210A outputs a plurality of pieces of result information including the first result information and the second result information to the control device 220. Here, the output of information to the control device 220 by the communication device 210 indicates the transmission of information by the intra-unit communication part 212 of the communication device 210. The transmitted information is received by the intra-unit communication part 222 of the control device 220. The above-described processing is performed in the same manner in the other communication devices 210 included in the communication unit 200 (communication device 210B, for example).

In such a configuration, the control device 220 is able to obtain a plurality of pieces of result information from each of one or more communication devices 210 having succeeded in receiving a wireless signal containing a plurality of pieces of result information. Therefore, if at least one communication device 210 of the plurality of communication devices 210 has succeeded in receiving a wireless signal containing a plurality of pieces of result information, the control device 220 is able to obtain all of the plurality of pieces of information. That is, the communication unit 200 of the embodiment allows failure in reception of a wireless signal, except the case where all the communication devices 210 fail in receiving a wireless signal.

Note that the success in reception of a wireless signal indicates the success in detection of a wireless signal by the reception side. That is, if the received power exceeds a given threshold, the reception of a wireless signal succeeds. For example, when the detection of a wireless signal containing a plurality of pieces of result information has succeeded, the communication device 210 determines that the reception has succeeded. Meanwhile, failure in reception of a wireless signal indicates the failure in detection of a wireless signal by the reception side. That is, if the received power is lower than a given threshold, the reception of a wireless signal fails. For example, if the detection of a wireless signal containing a plurality of pieces of result information does not succeed even when the elapsed time since the time of reception of the first distance measurement signal or the time of transmission of the second distance measurement signal has exceeded a given threshold, the communication device 210 determines that the reception has failed.

As a comparative example, in a communication unit including a plurality of communication devices and the control device, a communication device receives a wireless signal containing only result information obtained by wireless communication between the portable device and such a communication device and outputs the result information to the control device. In such a comparative example, it is difficult for the control device to obtain all of a plurality of pieces of result information unless all of the communication devices succeed in receiving a wireless signal.

As described above, the communication device 210 of the embodiment exerts higher robustness than the communication device of the comparative example in the aspect that the failure in reception of a wireless signal is allowed. Therefore, the communication unit 200 of the embodiment is able to perform processing based on one-to-many wireless communication more appropriately than the communication unit of the comparative example.

Characteristics Regarding Distance Measurement Communication

The wireless communication performed between the portable device 100 and each of the communication devices 210 may be distance measurement communication. Then, the result information may be information regarding a distance between the portable device 100 and the communication device 210. To be more specific, the communication device 210 may receive a wireless signal containing pieces of information regarding a distance between the portable device 100 and each of the communication devices 210 as a plurality of pieces of result information. Then, the communication device 210 may output the pieces of information regarding a distance between the portable device 100 and each of the communication devices 210 to the control device 220 as a plurality of pieces of result information. In such a configuration, the control device 220 is able to appropriately perform processing regarding the distance between each of the communication devices 210 and the portable device 100.

The information of the distance between the portable device 100 and each of the communication devices 210 may be information specified in accordance with wireless communication performed between each of the communication devices 210 and the portable device 100. To specify here indicates, for example, specifying the time of transmission or reception of a wireless signal and measuring a time length between specified time. In this configuration, the control device 220 is able to appropriately perform processing based on the information specified in accordance with wireless communication performed between each of the communication devices 210 and the portable device 100.

The information of the distance between the portable device 100 and each of the communication devices 210, which is included in the result information, may include at least one of a time length from the time of transmission of the first distance measurement signal to the time of reception of the second distance measurement signal (that is, ΔT1) at the portable device 100 and/or the time of transmission of the first distance measurement signal and the time of reception of the second distance measurement signal at the portable device 100. To be more specific, the communication device 210 may receive a wireless signal containing, as result information, at least one of a time length from the time of transmission of the first distance measurement signal to the time of reception of the second distance measurement signal (that is, ΔT1) at the portable device 100 and/or the time of transmission of the first distance measurement signal and the time of reception of the second distance measurement signal at the portable device 100. Then, the communication device 210 may output at least one of the time length from the time of transmission of the first distance measurement signal to the time of reception of the second distance measurement signal (that is, ΔT1) at the portable device 100 and/or the time of transmission of the first distance measurement signal and the time of reception of the second distance measurement signal at the portable device 100, to the control device 220. In such a configuration, the control device 220 is able to obtain ΔT1, which is obtained by distance measurement communication performed between the portable device 100 and each of the communication devices 210, or various time for calculating ΔT1. Particularly, if at least one communication device 210 of the plurality of communication devices 210 has succeeded in receiving a wireless signal containing a plurality of pieces of result information, the control device 220 is able to obtain such information.

Furthermore, the communication device 210 may output at least one of a time length from the time of reception of the first distance measurement signal to the time of transmission of the second distance measurement signal (that is, ΔT2) at the communication device 210 and/or the time of reception of the first distance measurement signal and the time of transmission of the second distance measurement signal at the communication device 210, to the control device 220. The communication device 210 outputs such information as well as a plurality of pieces of result information, regardless of whether the reception of a wireless signal containing the plurality of pieces of result information succeeds. In such a configuration, the control device 220 is able to obtain ΔT2, which is obtained by distance measurement communication performed between the portable device 100 and each of the communication devices 210, or various time for calculating ΔT2.

In the above-described configuration, the control device 220 is able to obtain ΔT1 and ΔT2, which are obtained by distance measurement communication performed between the portable device 100 and each of the communication devices 210, or various time for calculating ΔT1 and ΔT2. Particularly, if at least one communication device 210 of the plurality of communication devices 210 has succeeded in receiving a wireless signal containing a plurality of pieces of result information, the control device 220 is able to obtain such information. Therefore, the control device 220 is able to calculate a distance measurement value indicating a distance between the portable device 100 and each of the communication devices 210 except the case when the reception of a wireless signal containing a plurality of pieces of result information fails at all of the communication devices 210.

Here, the portable device 100 may transmit a wireless signal containing a plurality of pieces of result information obtained by wireless communication performed between the portable device 100 and each of the communication devices 210. That is, the communication device 210 may receive a wireless signal containing a plurality of pieces of result information from the portable device 100. For example, the wireless signal containing a plurality of pieces of result information may be a data signal received and transmitted in distance measurement processing. In such a configuration, the control device 220 is able to calculate a distance measurement value indicating a distance between the portable device 100 and each of the communication devices 210 except the case when the reception of a data signal fails at all of the communication devices 210.

The distance measurement communication may be performed individually between the portable device 100 and the communication devices 210. Meanwhile, a part of the distance measurement communication may be performed in common among the communication devices 210. To be more specific, the wireless communication performed between the portable device 100 and each of the communication devices 210 may include the transmission of the first distance measurement signal to the communication devices 210 by the portable device 100 and the transmission of the second distance measurement signal in response to the first distance measurement signal by each of the communication devices 210. That is, the portable device 100 transmits the first distance measurement signal once. Meanwhile, each of the communication devices 210 transmits the second distance measurement signal. In such a configuration, the portable device 100 only needs to transmit the first distance measurement signal once. Therefore, the portable device 100 does not need to individually transmit the first distance measurement signal to each of the communication devices 210, for example. In this manner, the increase of communication loads is prevented. The same applies to data communication.

Data Structure of a Wireless Signal

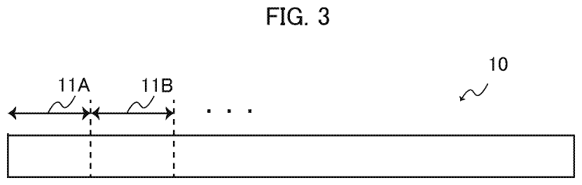

The wireless signal containing a plurality of pieces of result information may include, at a position defined for each of the communication devices 210, result information corresponding to each of the communication devices 210. For example, obtained result information of each of the communication devices 210 is stored in an area preliminarily assigned to each of the communication devices 210 in a payload part of a wireless signal. This will be described concretely with reference to FIG. 3.

FIG. 3 is a diagram for explaining an example of a data structure of a wireless signal received by the communication device 210 according to the embodiment. FIG. 3 illustrates a data structure of a payload part 10 including a plurality of pieces of result information in a wireless signal received by the communication device 210. A first element 11A of the payload part 10 includes result information related to the communication device 210A. A second element 11B of the payload part 10 includes result information related to the communication device 210B. The same applies to the result information of the other communication devices 210 among the plurality of communication devices 210 included in the communication unit 200.

Therefore, the communication device 210 is able to identify the information included in the first element 11A in the payload part 10 as result information related to the communication device 210A. Moreover, the communication device 210 is able to identify the information included in the second element 11B in the payload part 10 as result information related to the communication device 210B. The same applies to the result information related to the other communication devices 210 among the plurality of communication devices 210 included in the communication unit 200.

As described above, the communication device 210 having received a wireless signal is able to identify which communication device 210 the result information is related to, on the basis of a position of the result information. Therefore, the wireless signal does not need to contain identification information of the communication device 210. Therefore, it is possible to reduce the data amount of a wireless signal.

Processing Flow

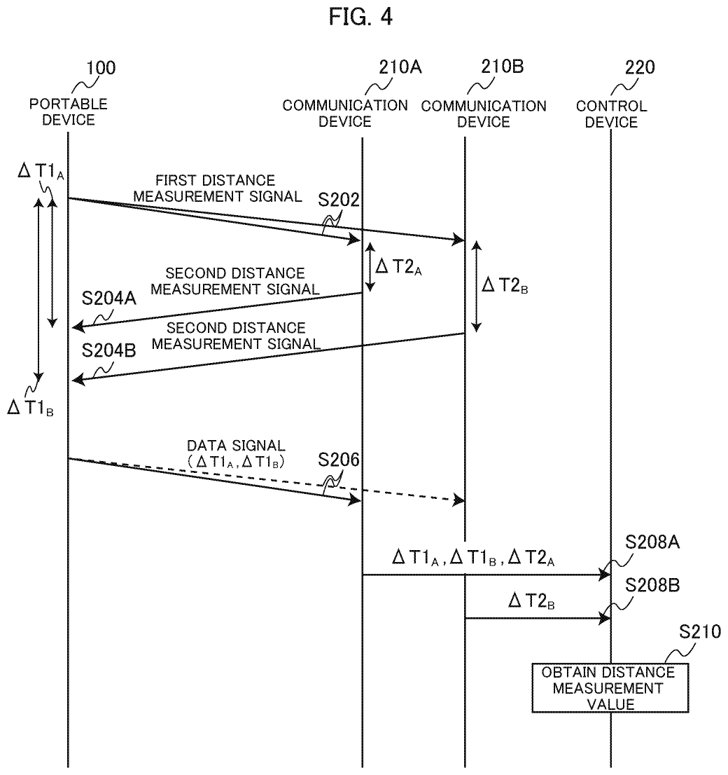

FIG. 4 is a sequence diagram illustrating an example of a flow of distance measurement processing performed by the system 1 according to the embodiment. As illustrated in FIG. 4, this sequence involves the portable device 100, a plurality of the communication devices 210, and the control device 220. Note that in this sequence, the communication unit 200 includes two communication devices 210 of the communication device 210A and the communication device 210B.

As illustrated in FIG. 4, the wireless communication part 110 of the portable device 100 transmits the first distance measurement signal (Step S202). The first distance measurement signal is transmitted as a signal using the UWB.

Having received the first distance measurement signal from the portable device 100, the wireless communication part 211 of the communication device 210A transmits the second distance measurement signal in response to the first distance measurement signal (Step S204A). The second distance measurement signal is transmitted as a signal using the UWB.

Similarly, having received the first distance measurement signal from the portable device 100, the wireless communication part 211 of the communication device 210B transmits the second distance measurement signal in response to the first distance measurement signal (Step S204B). The second distance measurement signal is transmitted as a signal using the UWB.

When the wireless communication part 110 has received the second distance measurement signal transmitted by the communication device 210A, the control part 130 of the portable device 100 measures time ΔT1_{A} from the time of transmission of the first distance measurement signal to the time of reception of the second distance measurement signal transmitted by the communication device 210A. Similarly, when the wireless communication part 110 has received the second distance measurement signal transmitted by the communication device 210B, the control part 130 of the portable device 100 measures time ΔT1_{B} from the time of transmission of the first distance measurement signal to the time of reception of the second distance measurement signal transmitted by the communication device 210B. Then, the wireless communication part 110 of the portable device 100 transmits data signals containing the measured ΔT1_{A} and ΔT1_{B} as a plurality of pieces of result information (Step S206). The data signal is transmitted as a signal using the UWB.

The control part 214 of the communication device 210A measures time ΔT2_{A} from the time of reception of the first distance measurement signal to the time of transmission of the second distance measurement signal. Thereafter, when the wireless communication part 211 has received a data signal from the portable device 100, the control part 214 of the communication device 210A outputs ΔT1_{A} and ΔT1_{B}, which are the result information included in the received data signal, and the measured ΔT2_{A}, to the control device 220 (Step S208A).

Similarly, the control part 214 of the communication device 210B measures time ΔT2_{B} from the time of reception of the first distance measurement signal to the time of transmission of the second distance measurement signal. Here, it is supposed that the wireless communication part 211 of the communication device 210B has failed in receiving a data signal from the portable device 100. In this case, the control part 214 of the communication device 210B outputs the measured ΔT2_{B} to the control device 220 (Step S208).

Then, the control device 220 obtains a distance measurement value indicating a distance between the portable device 100 and each of the communication devices 210 on the basis of the information obtained from each of the communication devices 210 (Step S210). To be more specific, the control device 220 calculates a distance measurement value indicating a distance between the communication device 210A and the portable device 100 on the basis of ΔT1_{A} and ΔT2_{A} obtained from the communication device 210A. Moreover, the control device 220 calculates a distance measurement value indicating a distance between the communication device 210B and the portable device 100 on the basis of ΔT1_{B} obtained from the communication device 210A and ΔT2_{B} obtained from the communication device 210B.

### 3. Supplement

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

For example, in the above-described embodiment, the communication device 210 outputs a plurality of pieces of result information included in a received wireless signal to the control device 220. However, the present invention is not limited to such an example.

As an example, the communication device 210 may output a distance measurement value indicating a distance between the portable device 100 and each of the communication devices 210 to the control device 220. For example, having received a data signal at Step S206 of the sequence illustrated in FIG. 4, the communication device 210A calculates a distance measurement value indicating a distance between the communication device 210A and the portable device 100 on the basis of ΔT1_{A} and ΔT2_{A}. Then, at Step S208A, the communication device 210A outputs ΔT1_{B} and the measured distance measurement value to the control device 220. In this case, the control device 220 does not need to calculate a distance measurement value indicating a distance between the communication device 210A and the portable device 100 at Step S210. Therefore, it is possible to reduce processing loads on the control device 220.

As another example, the communication device 210 may output information indicating a determination result based on a distance measurement value indicating a distance between the portable device 100 and the communication device 210 to the control device 220. For example, having received a data signal at Step S206 of the sequence illustrated in FIG. 4, the communication device 210A calculates a distance measurement value indicating a distance between the communication device 210A and the portable device 100 on the basis of ΔT1_{A} and ΔT2_{A}. Next, the communication device 210A determines whether the calculated distance measurement value is equal to or smaller than a given threshold. Then, at Step S208A, the communication device 210A outputs ΔT1_{B} and the determination result to the control device 220. In this case, the control device 220 does not need to calculate a distance measurement value indicating a distance between the communication device 210A and the portable device 100 at Step S210. Furthermore, the control device 220 does not need to compare the distance measurement value with a given threshold for authentication based on the distance measurement value. Therefore, it is possible to reduce processing loads on the control device 220.

In addition, for example, the information related to a distance between the portable device 100 and each of the communication devices 210, which is included in result information, is not limited to the information described in the above-described embodiment.

As an example, the information related to a distance between the portable device 100 and each of the communication devices 210 may be a distance measurement value indicating a distance between the portable device 100 and each of the communication devices 210.

As another example, the information related to a distance between the portable device 100 and each of the communication devices 210 may be information indicating a determination result based on a distance measurement value indicating a distance between the portable device 100 and the communication device 210.

Note that the calculation of a distance measurement value at the portable device 100 becomes possible by, for example, receiving a notification of time ΔT₂ from the time of reception of the first distance measurement signal to the time of transmission of the second distance measurement signal from the communication device 210. As another example, the calculation of a distance measurement value at the portable device 100 becomes possible by receiving a notification of the time of reception of the first distance measurement signal and the time of transmission of the second distance measurement signal from the communication device 210.

In addition, for example, in the above-described embodiment, the portable device 100 transmits the first distance measurement signal and the communication device 210 transmits the second distance measurement signal. However, the present invention is not limited to such an example. For example, the communication device 210 may transmit the first distance measurement signal, and the portable device 100 may transmit the second distance measurement signal.

Furthermore, for example, in the above-described embodiment, an authenticated party is the portable device 100, and an authenticating party is the communication unit 200. However, the present invention is not limited to such an example. The roles of the portable device 100 and the communication unit 200 may be reverse, or the roles may be switched dynamically. Moreover, the distance measurement and the authentication may be performed between the communication units 200.

Furthermore, for example, in the above-described embodiment, each of the communication devices 210 is provided in the vehicle 202. However, the present invention is not limited to such an example. The communication devices 210 only need to be provided in a single mobile body. Then, the mobile body is not limited to the vehicle 202. Other examples of the mobile body include an airplane and a ship. Similarly, the portable device 100 only needs to be a device carried by a user of a mobile body. Moreover, the control device 220 may not be necessarily provided in the same object as the communication device 210. For example, the communication device 210 and the control device 220 may be provided in mutually different objects.

Furthermore, for example, in the above-described embodiment, the present invention is applied to the smart entry system. However, the present invention is not limited to such an example. The present invention is applicable to an arbitrary system that performs distance measurement and authentication by transmitting and receiving signals. For example, the present invention is applicable to a pair including arbitrary two devices among a portable device, a vehicle, a smartphone, a drone, a house, a household electric appliance, and the like. In this case, one of the pair acts as an authenticating party and the other acts as an authenticating party. Note that the pair may include the same kind of two devices or include two devices of different kinds.

Furthermore, for example, in the above-described embodiment, a given wireless communication standard using the UWB is described. However, the present invention is not limited to such an example. For example, as a given wireless communication standard, those using Wi-Fi (registered trademark), Bluetooth (registered trademark), infrared light, and the like, may be used.

Furthermore, for example, in the above, the communication unit 200 is provided in the vehicle 202. However, the present invention is not limited to such an example. For example, the communication unit 200 may be partially or entirely formed as a separate body from the vehicle 202, such as a case where the communication unit 200 is provided in a parking lot of the vehicle 202. In such a case, the communication unit 200 may wirelessly transmit a control signal to the vehicle 202 so as to remotely control the vehicle 202, on the basis of the result of communication with the portable device 100.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

### REFERENCE SIGNS LIST

1 system
100 portable device
110 wireless communication part
120 storage part
130 control part
200 communication unit
202 vehicle
210 communication device
211 wireless communication part
212 intra-unit communication part
213 storage part
214 control part
220 control device
222 intra-unit communication part
223 storage part
224 control part

1. A communication device that is included in a plurality of communication devices performing wireless communication with a terminal device, the communication device comprising:
a wireless communication part that receives a wireless signal containing a plurality of pieces of result information including first result information obtained by wireless communication between the terminal device and the communication device and second result information obtained by wireless communication between the terminal device and another communication device of the plurality of communication devices; and
a control part that outputs the plurality of pieces of result information contained in the wireless signal to a control device that performs communication with each of the communication devices.

2. The communication device according to claim 1, wherein the wireless communication part receives the wireless signal containing information related to a distance between the terminal device and each of the communication devices as the plurality of pieces of result information, and
the control part outputs the information related to a distance between the terminal device and each of the communication devices to the control device as the plurality of pieces of result information.

3. The communication device according to claim 2, wherein the information related to a distance between the terminal device and each of the communication devices is information specified in accordance with wireless communication performed between each of the communication devices and the terminal device.

4. The communication device according to claim 1, wherein the wireless communication part receives the wireless signal from the terminal device.

5. The communication device according to claim 1, wherein the wireless communication performed between the terminal device and each of the communication devices include transmission of a first distance measurement signal to the communication devices by the terminal device and transmission of a second distance measurement signal in response to the first distance measurement signal by each of the communication devices.

6. The communication device according to claim 5, wherein the wireless communication part receives the wireless signal containing, as the result information, at least one of a time length from a time of transmission of the first distance measurement signal to a time of reception of the second distance measurement signal at the terminal device and/or the time of transmission of the first distance measurement signal and the time of reception of the second distance measurement signal at the terminal device, and
the control part outputs, as the result information, at least one of the time length from the time of transmission of the first distance measurement signal to the time of reception of the second distance measurement signal at the terminal device and/or the time of transmission of the first distance measurement signal and the time of reception of the second distance measurement signal at the terminal device, to the control device.

7. The communication device according to claim 5, wherein the control part outputs at least one of a time length from a time of reception of the first distance measurement signal to a time of transmission of the second distance measurement signal at the communication device and/or a time of reception of the first distance measurement signal and a time of transmission of the second distance measurement signal at the communication device.

8. The communication device according to claim 1, wherein the wireless signal contains, at a position defined for each of the communication devices, the result information corresponding to each of the communication devices.

9. The communication device according to claim 1, wherein the communication devices are provided in a single mobile body, and
the terminal device is a device carried by a user of the mobile body.

10. A terminal device performing wireless communication with each of a plurality of communication devices, the terminal device comprising:
a wireless communication part that transmits a wireless signal containing a plurality of pieces of result information obtained by wireless communication performed between the terminal device and each of the communication devices.

11. A data structure of a wireless signal used in a communication system including a terminal device and a plurality of communication devices, the data structure comprising:
a plurality of pieces of result information obtained by wireless communication performed between the terminal device and each of the communication devices, at a position defined for each of the communication devices.
